(19) United States
(12) Patent Application Publication
(10) Pub. No.: US 2025/0116466 A1
(43) Pub. Date: Apr. 10, 2025

(54) CONCENTRIC MULTIPLE-STAGE THERMAL ENERGY STORAGE SYSTEMS

(71) Applicant: SKIBO ENERGY SYSTEMS, LLC, Pittsburgh, PA (US)

(72) Inventors: Jacob RUSHKOFF, Charlotte, NC (US); Paul KLEMENCIC, Vancouver, WA (US)

(21) Appl. No.: 18/730,858

(22) PCT Filed: Feb. 14, 2023
(86) PCT No.: PCT/US2023/062613

§ 371 Date: Jul. 22, 2024

Related U.S. Application Data
(60) Provisional application No. 63/311,384, filed on Feb. 17, 2022.

(51) Int. Cl. F28D 20/00

(52) U.S. Cl. CPC F28D 20/0056

(57) ABSTRACT

Disclosed herein is a system and method for concentric multi-layer thermal energy storage device for thermal energy storage and powering other thermal energy consumption devices has a core of thermal storage material surrounded by concentric multi-layer thermal insulation material shells with thermal storage materials filled in the chambers between adjacent layers, inlets, and outlets for each chamber to allow thermal transfer material travel through the thermal energy storage materials between chambers within or between any one of the different energy storage devices and energy consumption devices.

### RELATED APPLICATIONS

The application claims priority from U.S. Provisional Patent Application No. 63/311,384, filed Feb. 17, 2022, the contents of which are hereby incorporated herein by reference in its entirety.

### TECHNICAL FIELD

This disclosure relates to thermal energy storage apparatus, controllers, and thermal energy storage control methods. More particularly, the present invention relates to thermal energy storage systems and use of energy storage material in the provision of heating and/or cooling systems in both centralized network (such as large industrial plants, combined heat and power plants and renewable energy power plants) and decentralized network (such as domestic and commercial buildings).

### BACKGROUND ART

Thermal Energy Storage (TES) in one form of energy storage using district heating and cooling systems serves as a reserve of thermal energy, which can be used to supply heat or cooling load in times of peak demand or in times of high energy prices—when heat is produced through other energy sources.

Thermal energy storage technologies store heat, for example, from active solar collectors, in an insulated repository for later use in space heating, domestic heating, industrial process heat, or to generate electricity.

The increasing use of renewable energy sources during the last two decades has increased the importance and value of energy storage systems. Thermal energy storage is much cheaper than electricity storage and it has a high potential for integrating intermittent energy sources such as wind and solar into the heating or cooling sector via heat pumps or electric boilers. TES helps reduce peak thermal demands, increase the efficiency of the energy system, and integrate other heat sources such as industrial waste heat.

TES applications may use different materials and engineering designs to achieve energy storage. Conventional TES applications use storage media such as water, rocks, minerals, and phase-change materials for heat storage. However, there are problems with the practical use of the existing systems, including but not limited to; achieving suitable rates of heat transfer in and out of the TES, acceptable levels of thermodynamic efficiency, and the limitation in effective integration of TES into heating and cooling energy systems.

The present application is directed toward providing an improved thermal energy storage apparatus with design that obviates or mitigates one or more of the aforementioned problems.

### SUMMARY OF INVENTION

Embodiments described in this application relate to a multi-stage thermal energy storage (mTES) device and a method and process of charging and discharging the mTES in thermal energy distribution system. The functions of multi-stage thermal energy storage unit include acting as a thermal energy reservoir to adjust the supply and demand of the thermal energy at different time points or different locations.

In embodiments of one described aspect, a multi-stage thermal energy storage device (mTES) includes a core of heat storage materials surrounded by at least two layers of concentric multi-layer shells in a thermal insulation material. The adjacent concentric thermal insulation material layers separate from each other by a concentric and enclosed chamber that is filled with thermal storage material. Each layer of shell connected with an inlet end and an outlet end to allow a fluid heat transfer material travel through the heat storage material. In embodiments of a further aspect, the fluid heat transfer materials can be fluid materials such as gas or liquid. In yet other embodiments, the heat transfer materials travel through the space within the heat storage material in form of pressurized fluid. In another embodiments, embedded tubes are used to carry the heat transfer material travel through the space within the heat storage material.

In yet other embodiments, the heat storage material in mTES are solid material, fluid material, or phase changing material. In embodiment of a further aspect described in the present application, the heat storage material is a stacked bricks with geometric shapes and grooves on surfaces. The geometric design and arrangement of the grooves on the bricks will allow bricks to form honeycomb shape space or various size and shapes of the spaces in between when stack up with different orientations. The different shapes of the space in between can allow the heat transfer material to travel through the space with controlled flow and pressure change.

In different embodiments, the mTES is configured to be elongated shape with concentric multi-layer structure inside. The elongated mTES has a first end and a second end wherein two inlet and outlet manifolds are configured to close the concentric chambers on each end in connection with the shells. In some embodiments, the inlet and outlets for each chamber are positioned in different ends.

In embodiments of another described aspect, when coupled with a heat source (HS) in T_{HS} temperature with sufficient thermal energy supply, a mTES when charges to its full capacity can have a maximum temperature Tc₁ in the core area and a minimum temperature of Ts₂ in other chambers away from the core. In another embodiment, when the HS temperature, T_{HS}, is higher than Tc₁, HS provide heat transfer material to the mTES's core and charge the mTES unit to approach its full capacity. If T_{HS}<Ts₂, the HS is considered below the mTES's thermal value threshold and will by-pass the mTES. If the Ts₂<T_{HS}<Tc₁, the HS is above the thermal value threshold, HS provides the heat transfer material to one of the chambers other than the core area. The heat transfer material completed exchange in an mTES reach temperature Tₒᵤₜ. In some cases, Tₒᵤₜ can be still above Ts₂. The heat transfer material after mTES exchange could be transfer back to one of the inlets by a feedback loop where the chamber temperature is less than Tₒᵤₜ.

In an embodiment of another described aspect, the HS can charge more than one mTES in a cascade wherein the HS by-pass one mTES unit may be used to charge a second mTES with a temperature below the thermal value threshold of the HS's temperature. In yet another embodiment, multiple HSs with different tiered temperatures can be connected to one mTES or a cascade of mTESs so that the higher temperature HS provides heat to higher temperature core or chambers or higher temperature hot end mTESs. In another embodiment, the output of one HS can charge an mTES or cascade of mTESs and then input to another HS to further charge other mTESs or other cascades of mTESs.

Additionally, at least one mTES are coupled with at least one energy consumption device (ECD) to output thermal energy. When connected with ECD, mTES release the heat transfer material to the ECD either from the core or other chambers to the ECD for the thermal energy exchange. In one embodiment, the ECD can be a power generator that converts thermal energy into other forms of energy, such as electricity. In a second embodiment, the ECD is a terminal device that radiates thermal energy into the environment directly. In a third embodiment, the ECD is a thermal energy storage device that can intake and preserve the thermal energy outputted from the mTES. In yet another embodiment, the ECD is a second multi-stage thermal energy storage unit with a core chamber temperature lower than the temperature of the released heat transfer material from the first mTES. In the embodiment of another described aspect, the ECD can discharge more than one mTES in a cascade wherein the ECD can by-pass one mTES unit may be used to discharge a second mTES which has a temperature above the thermal value threshold of the ECD's temperature. In yet another embodiment, the mTES or cascade of mTESs can be connected to multiple ECDs that have different tiered thermal energy needs wherein the mTES can first release the heated fluid to a ECD in the higher temperature range resulting in a decreased temperature in mTES. The mTES with the decreased temperature can further release the heated fluid to a second ECD that needs the temperature range to fall within the mTES's current chamber or core temperature range. In another embodiment, the output of one ECD can be reheated by an mTES and then input to another ECD.

### BRIEF DESCRIPTION OF DRAWINGS

By way of example, a specific exemplary embodiment of the disclosed system and method will now be described, with reference to the accompanying drawings.

FIG. 1 illustrates one example of a concentric multilayer shell structure for a mTES configuration. FIG. 1A is a perspective view showing a concentric tank that has an elongated axial unit with a manifold at each end of the unit and the manifold of the unit that connects the inlet and outlet of the chambers with extended pipes. FIG. 1B is a sectional view of the mTES unit cut along the elongated axial showing the concentric multilayer shell structure that defines each shell-shaped chamber and the core-chamber. FIG. 1C is the section view of the mTES unit cut perpendicular to the axial elongation illustrating the shell structure, the chambers, and the concentric configuration.

FIG. 2. illustrates the manifold configuration that connects the inlet or outlet to the chambers for the mTES unit. FIG. 2A is the perspective view of the manifold configuration; FIG. 2B is the section view of the manifold configuration.

FIG. 3 illustrates the various shapes of concentric multilayer shell structures for the mTES. FIG. 3A is a dorm-like concentric configuration. FIG. 3B is a round corner square shape concentric configuration. 301a and 301b show core-chamber structure, 303a, 303b, 305a,305b shows chambers between shells illustrated by 302a,302b, 304a, 304b, 306a, 306b. A pressure shell illustrated by 307a and 307b contains the other concentric shells and chambers.

FIG. 4 illustrates one embodiment of the thermal storage material that are grooved bricks such as brick blocks, as shown in FIG. 4C, and the view when stacked up inside the shell-shaped chambers and core-chamber, as shown in FIG. 4A and FIG. 4B.

FIG. 5 illustrates the process of charging a mTES from a Heat Source (HS).

FIG. 6 illustrates the process and system using mTES1 to power an Energy Consumption Device (ECD).

FIG. 7 explains the system and process of an mTES unit being charged with a heat source and a feedback charging loop. When If T_{HS}>Tc₁, charge the core-chamber that has a temperature of Tc₁; when If Tc₁>T_{HS}>Ts₂, charge the shell-shaped chamber that has a chamber temperature of Ts₂; when if Tᵢₙ<Ts₂, by-pass the mTES unit. When the temperature from the outlet of the core chamber, T_{out, core}>Ts₂, the system can reroute the thermal flow to the outer chamber with Ts₂.

FIG. 8 illustrates the system and process of an mTES unit discharging thermal energy to an Energy Consumption Device (ECD) with a feedback discharging loop.

FIG. 9 illustrates a system and method of managing thermal energy flow by multiple mTES in the cascade that takes charge from a Heat Source. When T_{HS} reaches a temperature number approximate with Tc₁, the system is designed to switch the operation model from FIG. 9A to FIG. 9B.

FIG. 10 illustrates a system and method of managing thermal energy flow with multiple mTES in the cascade that discharge thermal energy to an ECD. When T_{ECD} reaches a temperature number approximate with Tc₃, the system is designed to switch the operation model from FIG. 10A to FIG. 10B.

FIG. 11 illustrates a system and method of managing thermal energy flow by using multiple heat sources to charge a cascade of mTES units. FIG. 11A illustrates where two HS may be in sequence or parallel to provide mixed heat transfer fluid to the cascade of mTESs. When Tc₁>Tc₂>Tc₃>Tc₄>Tc₅ and when T_{HS1}˜Tc₁, mTES 2 takes the place of mTES1, mTES3 takes the place of mTES2, mTES4 takes the place of mTES3, and mTES5 takes the place of mTES4 FIG. 11B illustrates where the HSs are separately connected to the mTES cascade to charge any subset of the mTES cascade. FIG. 11C illustrates that multiple HSs are separately connected to multiple mTES cascade to charge any subset of the mTES units where Tc₁>Tc₂>Tc₃>Tc₄>Tc₅, when the temperature difference between T_{HS1} and Tc₁ fall below a minimum threshold, mTES 2 takes the place of mTES 1, mTES3 takes the place of mTES2, mTES4 takes the place of mTES3, and mTES5 takes the place of mTES4.

FIG. 12 illustrates a system and method of managing thermal energy flow by using a cascade of mTES units to provide thermal energy to multiple ECDs. FIG. 12A illustrates where two ECD may be in sequence and take additional thermal compensation from one of the mTES units. FIG. 12B illustrates where the multiple ECDs are independent and separately connected to one mTES cascade as an energy source.

### DESCRIPTION OF EMBODIMENTS

It will be appreciated that, although specific embodiments of the subject matter of this application have been described herein for illustration, various modifications may be made without departing from the spirit and scope of the disclosed subject matter. Accordingly, the subject matter of this application is not limited except by the appended claims.

In the following description, certain specific details are set forth in order to provide a thorough understanding of various disclosed embodiments. However, one skilled in the relevant art will recognize that embodiments may be practiced without one or more of these specific details or with other methods, components, materials, etc. In other instances, well-known structures associated with thermal energy storages have not been described in detail to avoid unnecessarily obscuring descriptions of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. The use of ordinals such as first, second, and third does not necessarily imply a ranked sense of order but rather may only distinguish between multiple instances of an act or structure.

Reference to an energy consumption device means any device capable of consuming thermal energy and releasing stored energy, including, but not limited to, industrial processes, power generators, district heating, or another mTES that need to be charged up and modules made up of a plurality of the same. Reference to heat sources means industrial waste heat, concentrated solar thermal (CST), geothermal heat derived from other energy sources, other mTES(s), or any unit that can provide heat fluid with a temperature. A non-limiting example of an mTES is illustrated in the figures as cylindrical; however, the present disclosure is not limited to this illustrated form factor.

The headings and Abstract of the Disclosure provided herein are for convenience only and do not interpret the scope or meaning of the embodiments.

Generally described, the present disclosure is directed to examples of concentric multilayer thermal storage devices suitable to be charged, recharged, or discharged in any power distribution network where the need to balance thermal supply and demand, integrate renewable energy, or recover waste heat may arise. Further description of mTES in accordance with embodiments described herein is provided in the context of mTES used with hot air fluid and system generate electric power by thermal energy; however, the mTES devices in accordance with embodiments described herein are not limited to applications in hot air fluid and electric power generation system. In addition, mTES devices are described below with reference to a single mTES module containing a plurality of mTES units and a plurality of thermal energy supply sources and energy consumption devices. The present description is not limited to thermal energy storage devices that include only a single mTES unit.

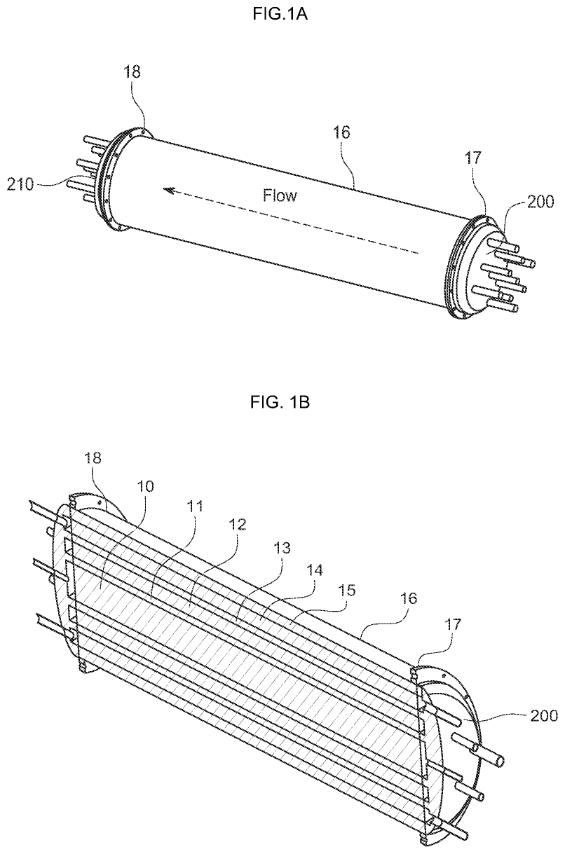

Referring to FIG. 1C, a multi-stage thermal energy storage (“mTES”) unit has elongated concentric multi-layer shells (11, 13, 15) made from rigid non-combustible thermal insulation material. The space between adjacent shells defines plurality shell-shaped chambers (12,14) which are filled with thermal storage material (40). The thermal storage material can be solid material, fluid material, or phase-changing material; a core-chamber (10) is defined by the shell (11) that is nearest to the geometric center of the Units and filled with the thermal storage material and form the core of the mTES unit. A pressure container (16) that is the most distance from the geometric center of the Unit is made from rigid non-combustible thermal insulation material that sustains high-pressure operation.

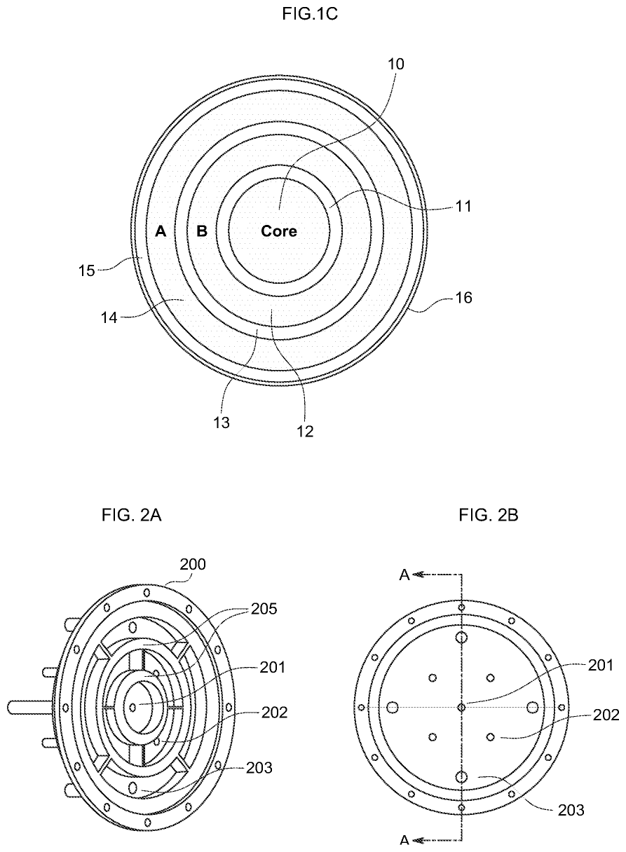

Referring to FIGS. 1A and 1B, the elongated Unit has an inlet ends (17) and an outlet end (18), wherein the inlet end is connected with the first manifold (200) and serve as a lid that has a matrix of headers and branched piping that can be used to distribute heat transfer material received from the upstream process and directed to the inlet end for different chambers; the outlet end is connected with a second manifold (210) that has a mirror structure of the first manifold which also has a matrix of headers and branched piping that can be used to distribute heat transfer fluids received from each chamber and directed toward the different downstream process. Referring to FIG. 2A, the manifold has concentric lip structures (205) on the side directly connected with mTES's outlet or inlet end to close the chambers defined by the concentric shells. Referring to FIG. 2B the manifolds have openings connect to matrix of headers and branched piping.

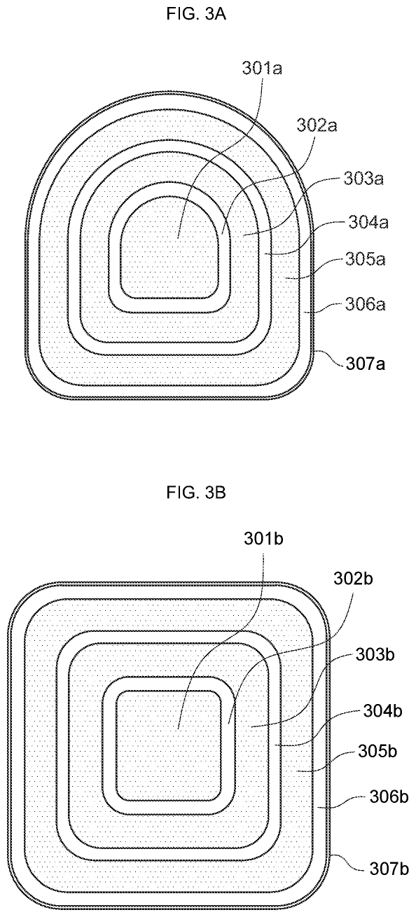

Referring to FIG. 3A, FIG. 3B, the section views perpendicular to the axial elongation of the concentric configuration of variation of mTES units.

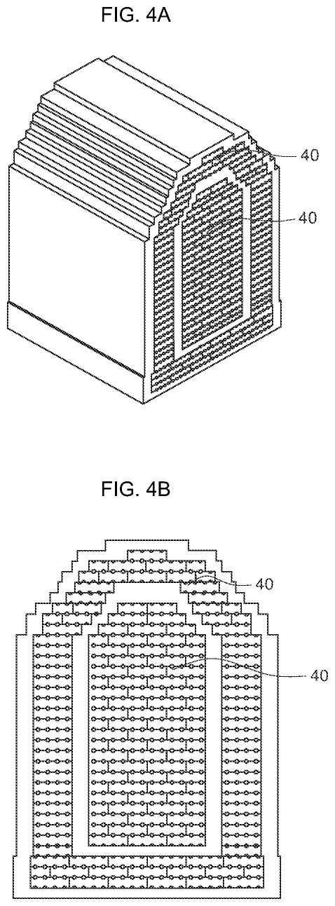

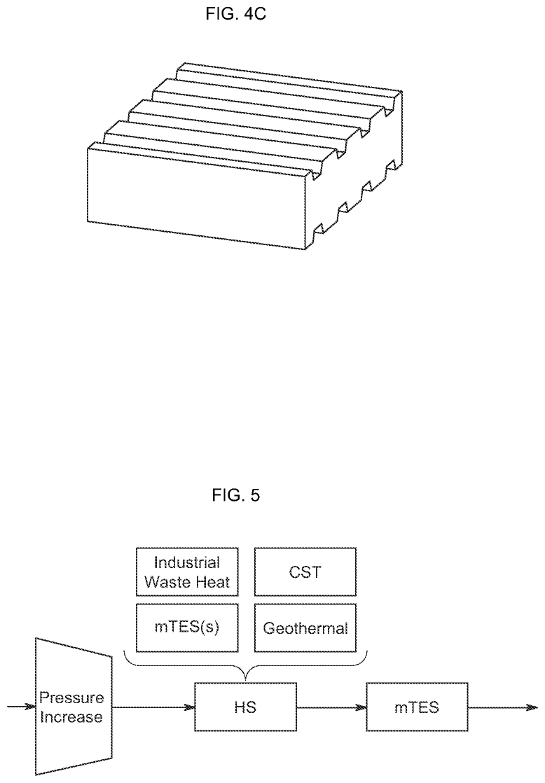

Referring to FIG. 4C, the thermal storage materials can be a grooved bricks as one of the embodiments for the thermal storage material that enables the heat transfer material travel within the chambers to exchange thermal energy. When stacked inside the chambers, referring to FIG. 4A and FIG. 4B the thermal capacity of the stack of bricks forms the basis to calculate the chamber's thermal capacity. Further, the geometric design and arrangement of the grooves on the bricks form space and channels that allow the heat transfer material to travel through the chamber with the controlled flow and pressure changes. The designed brick surface also allows the bricks to stack with each other in a controlled manner in various orientations to form the different sizes of space and channels between the bricks enabling the heat transfer material to travel through the chamber in various flow and pressure changes.

In accordance with embodiments described herein, referring to FIG. 5, a system and method of managing thermal energy by using a heat source (HS) to charge a mTES unit. In some embodiments, the HS can be industrial waste heat, concentrated solar thermal (CST), geothermal heat derived from other energy sources, other mTES(s), or any unit that can provide heat fluid with a temperature.

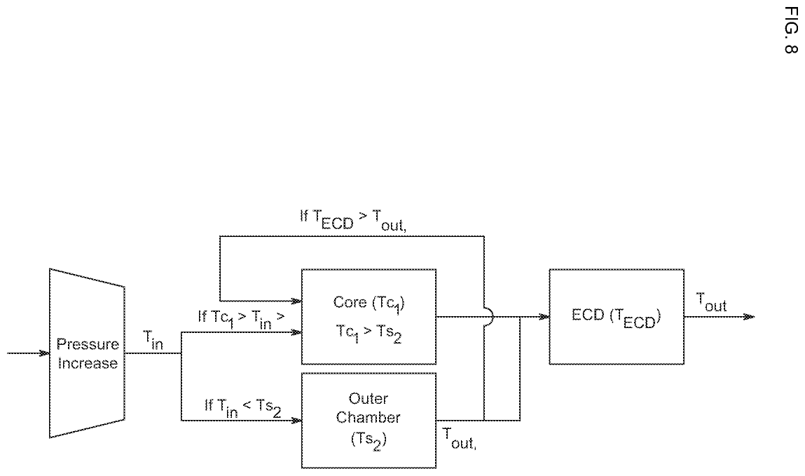

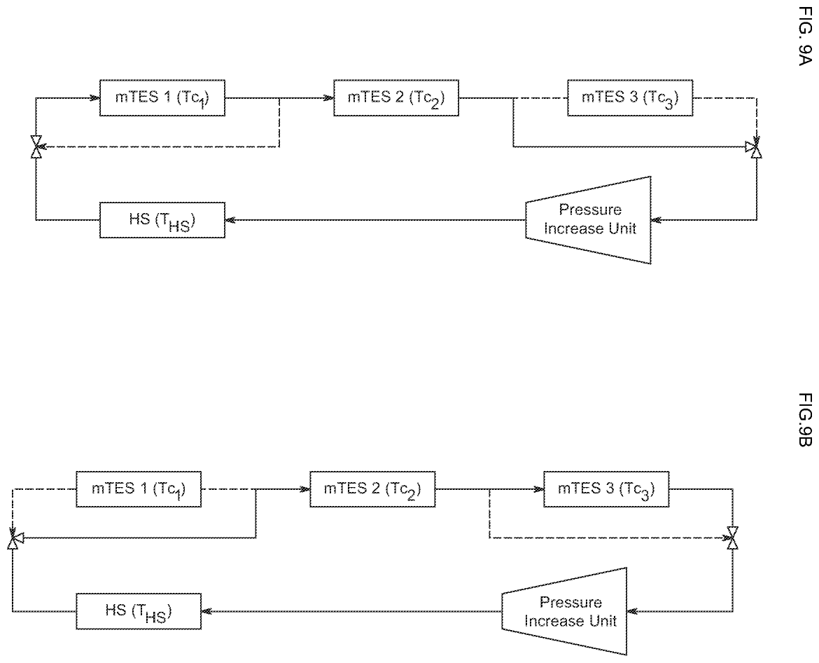

In one aspect, referring to FIG. 7, the mTES that need to be charged, it has a core-chamber temperature in Tc₁ and at least one shell-shaped chamber's temperature in Ts₂. In general, the core-chamber always has a higher temperature within the mTES than the shell-shaped chambers. The mTES first receives the heated transfer material that may be pressured and has a temperature in T_{HS} from a heat source (HS). If the heat source provides the heat transfer material with a higher temperature than the core-chamber (T_{HS}>Tc₁), the heat transfer material will be directed to travel through the core-chamber of the mTES. If the heat source provides the heated transfer material with a temperature below the core-chamber, but above one of the shell-shaped chambers (Tc₁>T_{HS}>Ts₂), the heat transfer material will be directed to travel through the shell-shaped chambers of the mTES that have temperatures below T_{HS}. The temperature for the heat transfer material after traveling through the mTES will drop to Tₒᵤₜ. In some aspects, the system has a feedback charging loop if the Tₒᵤₜ is higher than Ts₂, where the system will direct the heat transfer material back to charge a specific shell-shaped chamber with a temperature lower than Tₒᵤₜ. The multilayer configuration of mTES provide different temperature zone and allows the mTES unit to use the feedback loop to charge different chambers and avoid wasting the thermal energy from the HS. In another aspect, when the T_{HS} and Tₒᵤₜ is lower than Ts₂, the HS is considered to have no charging value for the mTES unit. The heat transfer material from the heat source shall be directed to by-pass the mTES unit, or not have the feedback charging loop.

In another embodiment, a mTES have N number of shell-shaped chambers in temperature of Tₙ. When the heat transfer material completes at least one exchange inside at least one of the chambers of the mTES and still has a temperature higher than any one of the chamber temperature Tₙ, the system can redirect the heat transfer material back to the mTES chamber with the lower temperature to continue the heat exchange.

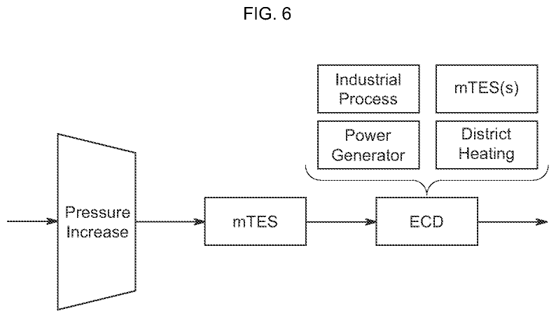

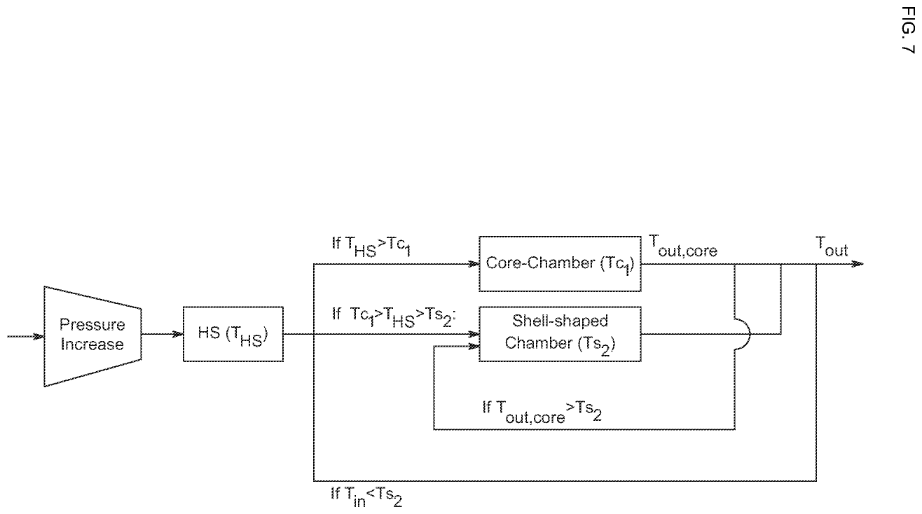

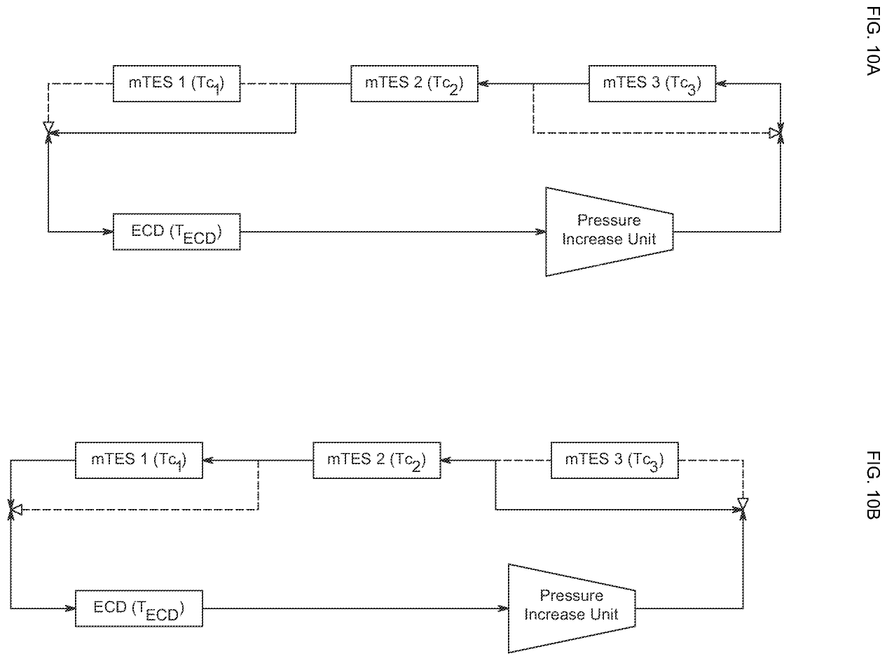

Referring to FIG. 6, a system and method of managing thermal energy by using a mTES including the aspect of discharging the thermal energy from a mTES to an energy consumption device (ECD) that can be characterized by its temperature value T_{ECD}. In some embodiments, the ECD can be an industrial process, power generator, district heating, or another mTES that needs to be charged up. Referring to FIG. 8, the mTES is characterized by the core-chamber temperature Tc₁, and any of the shell-shaped chamber temperatures Ts₂. When connected with ECD, if T_{ECD} is below Ts₂, where T_{ECD} will be certain to below Tc₁, the system determines that mTES can discharge the heat transfer material from the core-chamber and the shell-shaped chamber to ECD directly. However, when only Tc₁ is above the T_{ECD}, the system will only direct the core-chamber heat transfer material from the mTES to the ECD. The heat transfer material discharged from the shell-shaped chamber will be directed back to the core-chamber of the same mTES unit. This feedback allows the mTES to discharge all the thermal energy it has to the ECD until the output from any chamber of the mTES unit is equal to the ECD's temperature value T_{ECD}.

In another embodiment, a mTES have N number of shell-shaped chambers in temperature of Tₙ. When the heat transfer material from at least one of the shell-shaped chambers of the mTES has a temperature lower than T_{ECD}, and the core-chamber's temperature (Tc₁) is higher than the T_{ECD}, the system can redirect the heat transfer material from the N chamber back to the core-chamber before the heat transfer material can be sent to ECD directly.

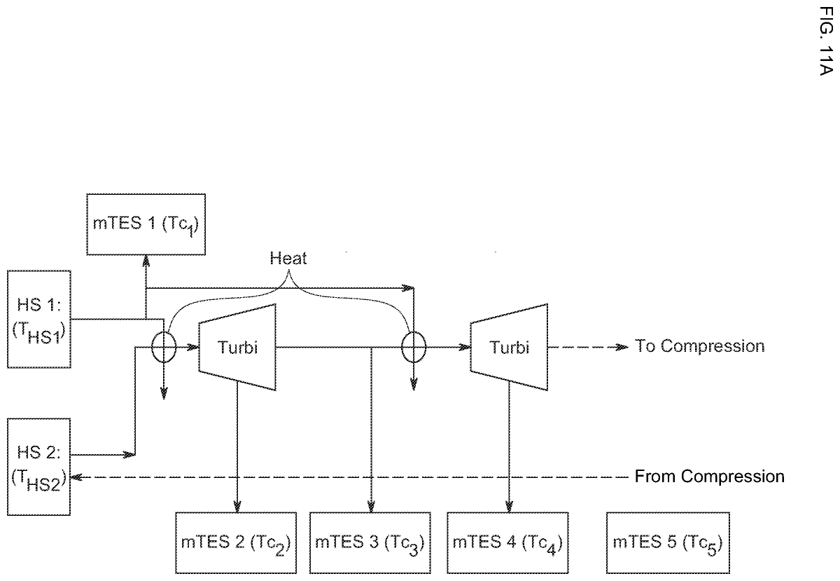

In another embodiment, a system and method of managing thermal energy include a plurality of mTES units working in sequence to extract the most thermal energy value from an HS using a direct cascading charging process. The mTES units in different temperature value act like reservoirs at different heights for a cascading waterfall with a by-passing option. Referring to FIG. 9A, by way of example, three mTES, mTES1, mTES2 and mTES3 have their core-chamber temperature characterized as Tc₁, Tc₂, and Tc₃. The mTES units can be connected in sequential and coupled with a HS with T_{HS}. whereas T_{HS}≥Tc₁≥Tc₂≥Tc₃. At the initial stage of the charging process, mTES units in sequence are within a small temperature range but all be below T_{HS}. More specifically, T_{HS}>Tc₁>Tc₂, and Tc₂ would be approximate to Tc₃. The multiple mTES units in sequence form a cold end represent by mTES3 and a hot end represented by mTES1. The system selects the mTES unit from the hot end in the sequence of the multiple mTES units to be connected to HS first. The system may select only a subset of the units from the cold end to be in the loop when an mTES unit from the hot end is directly connected to HS for efficient heat transfer.

Referring to FIG. 9A, the system connects HS with an mTES unit from the hot end (i.e. mTES1). The mTES1 first receives the heat transfer material from HS and subsequently into the next mTES in line until the difference between the T_{HS} and Tc₁ is no longer significant enough for efficient heat transfer between the HS and mTES1 unit. The difference between T_{HS} and Tc₁ may be a threshold number determined by the system efficiency. Referring to FIG. 9B, When T_{HS} and Tc₁'s difference falls below the threshold, the system will direct the heat transfer material from HS to exchange heat with the next mTES inline (mTES 2 and mTES 3) directly. The mTES2 will receive the output of HS directly when mTES 2 become the next hot end of the chain. The mTES2's charging will end when Tc₂ reaches the approximate to T_{HS}.

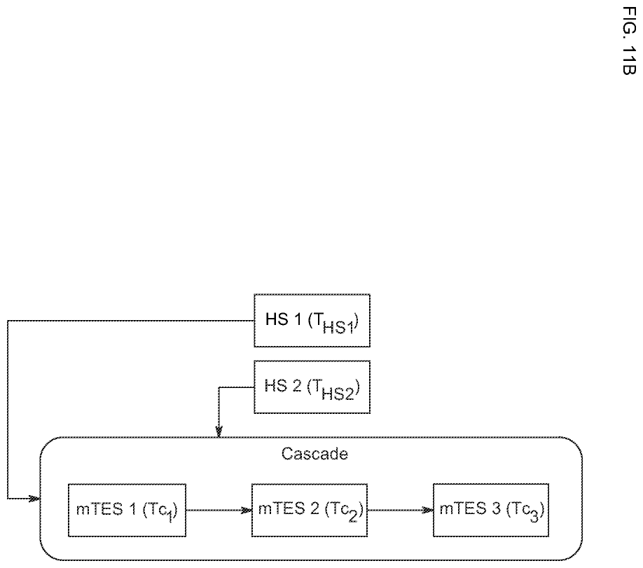

In some embodiments, a system and method of managing thermal energy include a plurality of mTES units working in sequence to provide the most efficient thermal energy to an ECD using a direct cascading discharging process. The mTES units in different temperature value act like reservoirs at different heights for a cascading waterfall with a by-passing option. Referring to FIG. 10A, by way of example, three mTES, mTES1, mTES2 and mTES3 have their core-chamber temperature characterized as Tc₁, Tc₂, and Tc₃. Tc₁, Tc₂, Tc₃ may be changing during the process. However, it always stands Tc₁≥Tc₂≥Tc₃≥T_{ECD}. At the initial stage of the discharging process, mTES units in sequence are within a small temperature range, but all be above T_{ECD}. Tc₁ would be approximate to Tc₂, and Tc₂>Tc₃, Tc₃>T_{ECD}. The multiple mTES units in sequence form a cold end represented by mTES3, and a hot end represented by mTES1. The system selects the mTES unit from the cold end in the sequence of the multiple mTES units to be connected to ECD first. The system may select only a subset of the units from the hot end to be in the loop when an mTES unit from the cold end is directly connected to ECD for efficient heat transfer. Referring to FIG. 10A, the system connects ECD with an mTES unit from the cold end (i.e., mTES3). The mTES3 first receives the heat transfer material from ECD and subsequently into the next mTES in line until the difference between the T_{ECD} and Tc₃ is no longer significant enough for efficient heat transfer between the ECD and mTES3 unit. The difference between T_{ECD} and Tc₃ may be a threshold number determined by the system efficiency. Referring to FIG. 10B, When T_{ECD} and Tc₃'s difference falls below the threshold, the system will direct the heat transfer material from ECD to exchange heat with the next mTES inline (mTES 2 and mTES 1) directly. The mTES2 will receive the output of ECD directly when mTES 2 become the next cold end of the chain. The mTES2's discharge will end when Tc₂ reaches the approximate T_{ECD}.

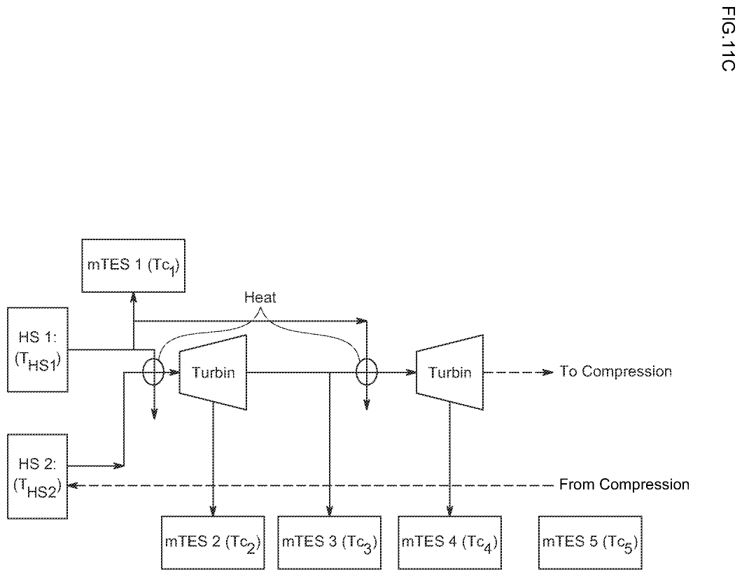

In other embodiments, the chain of multiple mTES may be charged from Heat Sources with different temperatures. Referring to FIG. 11, HS1 and HS2 are two heat sources with different temperature characteristics (T_{HS1}, T_{HS2}). A chain of the mTES (i.e., mTES1 to mTES5) is prepared to exchange heat with any one of the heat sources available. The multiple mTES units are characterized by the core chamber temperature Tc₁≥Tc₂≥Tc₃≥Tc₄≥Tc₅. At the initial stage, Tc₄ is approximately Tc₅. Any one of the HS can be selected to connect with any of the mTES units to start the cascading charging similarly to what is described in FIG. 9 if the temperature of HS is sufficiently greater than the mTES unit to be connected for efficient charging.

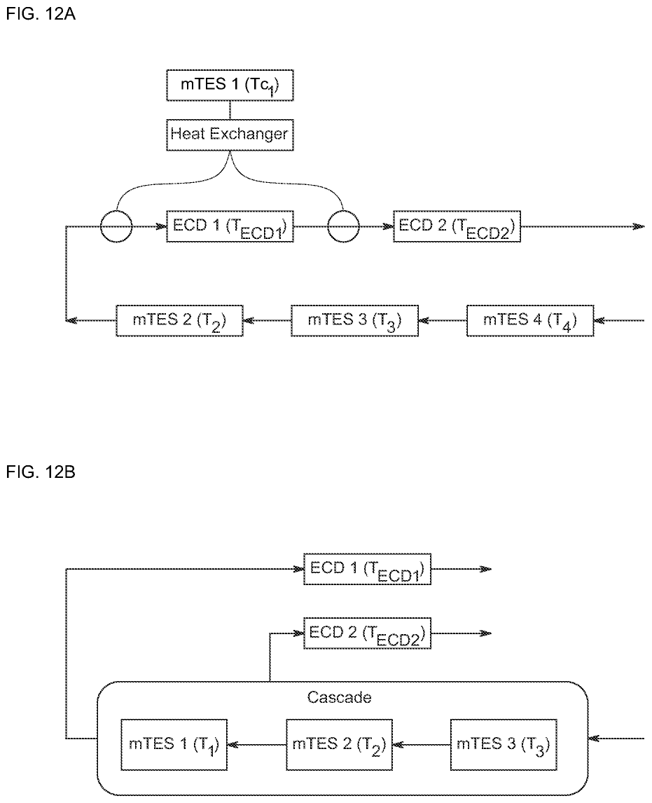

In another embodiment, a cascading discharging process can support more than one ECD. Any one of the multiple ECDs, ECD1, and ECD2, can take discharging from a cascade of mTES1 to mTES 4 in a similar discharging process described in FIG. 10. Referring to FIG. 12A, in some aspects, mTES1 (the hot end of the discharging cascade) can be used as to compensate for the temperature drop after the first ECD exchange and enable a subsequent or second ECD to intake the output from the first ECD. Referring to FIG. 12B, in some other embodiments, independent multiple ECDs can be connected to a different subset of the mTES chain when the temperature of the mTES cascade subset is sufficient to provide the heat source for each of the ECD.

Although embodiments including a single mTES unit, single HS, and single ECD have been described above with reference to FIGS. 1 to 12, in accordance with the subject matter described herein, multiple mTES and HS and ECD can be provided. When more than two mTES, HS, and ECD are provided, in accordance with embodiments described herein, compressors, sensors for temperatures and pressures, flow meter, pump, valves, or other parameters are provided to maintain the mass flow, in accordance with embodiments described herein.

The above description of illustrated embodiments, including what is described in the Abstract, is not intended to be exhaustive or to limit the embodiments to the precise forms disclosed. Although specific embodiments and examples are described herein for illustrative purpose, various equivalent modifications can be made without departing from the spirit and scope of the disclosure, as will be recognized by those skilled in the relevant art.

These and other changes can be made to the embodiments considering above detailed description. In general, in the following claims, the terms used should be construed to limit the claims to the specific embodiments disclosed in the specification and the claims but should be construed to include all possible embodiments along with the full scope of equivalents to which such claims are entitled. Accordingly, the claims are not limited by the disclosure.

1. A multi-stage thermal energy storage (“mTES”) unit comprising:
a concentric multi-layer shell, each shell made from any thermal insulation material;
a plurality of shell-shaped chambers defined by adjacent shells wherein the chambers are filled with a thermal storage material that can be solid, fluid material, or phase-changing material, wherein the shell-shaped chambers are filled with the thermal storage materials that determine a minimum thermal capacity of any one of the shell-shaped chambers represented by a temperature Ts;
a core-chamber defined by the shell that is nearest to the geometric center of the mTES wherein the core-chamber is filled with the thermal storage materials that determine a maximum thermal capacity of the core-chamber represented by a temperature Tc; and
an inlet and an outlet connected to each of the concentric multi-layer shells to allow a heat transfer material to travel through each chamber, including each of the plurality shell-shaped chambers and the core-chamber, independently wherein the heat transfer materials may be fluid materials such as gas or liquid.

2. The mTES unit, according to claim 1, wherein said thermal storage material is a plurality of solid bricks that stacks up, each solid brick has a geometric design and, when being stacked up, will form a plurality of fluid channels in between bricks and allow the heat transfer materials flow through the fluid channels and travel through the shell-shaped chambers and the core-chamber in a controlled speed between the chambers' inlet and outlet.

3. The thermal storage material in claim 2 wherein the individual solid brick's geometric design is patterned grooves on at least one of the surfaces of the brick.

4. The mTES unit in claim 1 further comprises: a plurality tubes embedded within the thermal storage materials to carry the heat transfer materials that flow through the thermal storage materials wherein the plurality tubes are converged at two points where one converging point is connected to the inlet of the shell, and the other converging point is connected to the outlet of the shell.

5. The mTES unit, according to claim 1, the concentric multi-layer shell that is furthest to the center of the unit is made from materials that is optimized to sustain pressure operation inside the TES unit.

6. The mTES unit, according to claim 1, the concentric multi-layer shell of each chamber is made from a thermal insulation material.

7. The mTES unit in, according to claim 1, the concentric multi-layer shell of each chamber has a minimum thickness of design to control heat from diffusing into adjacent chambers, wherein each shell's thickness may be calculated to be the same or different.

8. The mTES unit, according to claim 1, the size of each chamber is calculated to have space to house sufficient thermal storage materials that hold the desired amount of energy within the chamber's predetermined temperature ranges as different temperature stages.

9. The mTES unit, according to claim 1, wherein the outlet of the core chamber has an optional connection with at least one inlet of at least one shell-chamber and forms a direct heat exchange loop between the core-chamber and any of the shell chambers.

10. A method for charging an mTES unit, comprising steps of:
having an mTES unit, wherein the mTES has a core-chamber filled with the thermal storage material, and the core-chamber is surrounded with concentric multi-layer heat insulation shells wherein adjacent shells forming a plurality of shell-shaped chambers and each shell-shaped chambers and core-chamber are filled with thermal storage materials, each shell has an independent inlet and outlet open to the space inside the shell-shaped chambers or core-chamber, said inlet and outlet are connected to a heat source and to allow the heat transfer materials travel through all the shell-chambers, and the core-chamber;
having one of the shell-shaped chambers or the core-chamber be a receiving chamber and receiving the heat transfer material from the heat source, wherein the heat source provides the heat transfer material with a temperature higher than the receiving chamber, wherein the heat transfer material travel with a controlled pressure through the receiving chambers via the inlet that connects to the receiving chamber and allows heat exchange with the thermal storage materials within the receiving chamber;
releasing the heat transfer material from the receiving chambers through the outlet of the receiving chamber;
continuously receiving the heat transfer material from the heat source and releasing the heat transfer material after it travels through the receiving chambers until after said receiving chambers reach a targeted temperature; and
directing the heat transfer material to bypass the mTES unit and rejoin the flow from the heat source when the temperature at the outlet of the receiving chamber reaches a predetermined temperature range.

11. A method for charging an mTES unit according to claim 10, wherein the heat source may be a plurality of mTES that are connected with each other in sequential or parallel via channels or valves, wherein when at least one shell shaped-chambers or core-chamber has a temperature within a first mTES is lower than the released heat transfer material from any chambers from a second mTES, the first mTES may receive the high temperature heat transfer material from the second mTES.

12. A method for charging an mTES unit according to claim 10, wherein when the heat transfer material released from any one of the shell-shaped chambers or core-chamber has a temperature higher than the temperature of other chambers, the heat transfer with higher temperature may be rerouted back to the inlet of the chamber that has a lower temperature to continue the heat exchange with the heat storage material inside the same mTES unit;

13. A method for charging an mTES unit according to claim 10 wherein the heat source may be a power generator that can output heated transfer material such as hot steams or hot air from a power field, concentrated solar thermal heat, geothermal heat, electric heater, furnace, process waster heat.

14. A method for discharging an mTES unit, comprising steps of:
having at least one mTES unit to be connected to at least one thermal energy consumption device, and the mTES has a core-chamber filled with heat storage material, and the core-chamber is surrounded with a concentric multi-layer heat insulation shells wherein adjacent shells forming a plurality of shell-shaped chambers and each chamber are filled with thermal storage materials, each shell has an independent inlet and outlet open to the space inside the shell-shaped chamber or core-chamber and connects to a heat source to allow any heat transfer materials travel through the core-chamber and the shell-shaped chambers;
allowing the heat transfer material from at least one of the chambers from at least one mTES unit to be released to the thermal energy consumption device through the outlet of the chamber connected with the thermal energy consumption device, wherein the thermal energy consumption device exchange the thermal value with the heat transfer material and converts the thermal energy to another form of energy such as electricity and resulting the heat transfer material after the exchange with a lower thermal value; and
directing the heat transfer material with a lower thermal value after the thermal energy consumption device to a second thermal energy consumption device that may utilize the thermal value or directing the heat transfer material to rejoin the heat source or release the heat transfer material into the air.

15. A method for discharging an mTES unit, according to claim 14, wherein the thermal energy consumption device can be a power generator that converts thermal energy into another form of energy, such as electricity.

16. A method for discharging an mTES, according to claim 14, wherein the thermal energy consumption device can be a terminal device that directly radiates thermal energy into the environment.

17. A method for discharging an mTES, according to claim 14, wherein the thermal energy consumption device can be another multi-stage thermal energy storage unit with a core chamber temperature lower than the temperature of the released heat transfer material from the discharging mTES.

18. A method of operating the thermal energy storage unit using the mTES unit, according to claim 10, the method comprising:
having an mTES unit, wherein the mTES has a core-chamber filled with the thermal storage material, having a core heat generation device resides inside the core-chamber, wherein the core heat generation device may be powered by electricity, magnetic field, microwave, radiation, laser, radio frequency, chemical reaction, or any physical force, and the core-chamber is surrounded with concentric multi-layer heat insulation shells wherein adjacent shells forming a plurality of shell-shaped chambers and each shell-shaped chambers and core-chamber are filled with thermal storage materials, each shell has an independent inlet and outlet open to the space inside the shell-shaped chambers or core-chamber, said inlet and outlet are connected to a heat source and to allow the heat transfer materials travel through all the shell-chambers, and the core-chamber;
having one of the shell-shaped chambers or the core-chamber be a receiving chamber and receiving the heat transfer material from the heat source, wherein the core heat generation device provides the heat transfer material with a temperature higher than the receiving chamber, wherein the heat transfer material travel with a controlled pressure through the receiving chambers via the inlet that connects to the receiving chamber and allows heat exchange with the thermal storage materials within the receiving chamber;
releasing the heat transfer material from the receiving chambers through the outlet of the receiving chamber;
continuously receiving the heat transfer material from the heat source and releasing the heat transfer material after it travels through the receiving chambers until after said receiving chambers reach a targeted temperature; and
directing the heat transfer material to bypass the mTES unit and rejoin the flow from the heat source when the temperature at the outlet of the receiving chamber reaches a predetermined temperature range.
